(19) United States
(12) Patent Application Publication
(10) Pub. No.: US 2009/0122863 A1
(43) Pub. Date: May 14, 2009

(54) Video transcoding techniques for gaming networks, and gaming networks incorporating the same

(75) Inventor: David J. Gacke, Island Lake, IL (US)

Correspondence Address: NIXON & VANDERHYE, PC, 901 NORTH GLEBE ROAD, 11TH FLOOR, ARLINGTON, VA, 22203, US

(73) Assignee: PALTRONICS, INC., Crystal Lake, IL (US)

(21) Appl. No.: 11/979,883

(22) Filed: Nov. 9, 2007

(51) Int. Cl. H04N 11/02

(52) U.S. Cl. 375/240.12

(57) ABSTRACT

The exemplary embodiments described herein relate to light-weight video transcoding techniques for allowing media (e.g., audiovisual content that may be pre-recorded media and/or live media provided in substantially real-time) to one or more peripherals (e.g., gaming devices, overhead displays, etc.) attached to gaming networks. In certain exemplary embodiments, video data to be distributed is received from a video server. The video data is decompressed into raw video data. The raw video data is stripped down by discarding at least some component data of the raw video data and at least some lower bits of the raw video data. A predictor algorithm is run on the stripped-down raw video data. Recompressed data to be sent to one or more peripherals is generated based on output of the predictor algorithm in accordance with a compression algorithm. The recompressed data may be received at at least one peripheral, the recompressed data may be decompressed, and existing component data may be substituted for the discarded component data.

### TECHNICAL FIELD

The exemplary embodiments described herein relate to video transcoding techniques for gaming networks and, more particularly, to light-weight video transcoding techniques for allowing media (e.g., audiovisual content that may be pre-recorded media and/or live media provided in substantially real-time) to one or more peripherals (e.g., gaming devices, overhead displays, etc.) attached to gaming networks.

### BACKGROUND AND SUMMARY

For years, gaming machines (e.g., of the type typically found in casinos, on riverboats, and/or in other gambling establishments) have provided patrons with enjoyment and proprietors with revenue. Broadly speaking, they have evolved from simple, classic slot machines featuring mechanical arms that a patron would pull, to more complicated video-based versions of slots, poker, and other games, with one or more buttons sometimes replacing the functions served by the mechanical arm. Further changes have included, for example, incorporating multiple displays to support advertising and/or even additional games.

As the desire for more engaging entertainment has increased yet further, some providers have configured their gaming machines for use in a networked environment. The use of the networked environment has enabled the implementation of progressive jackpot games, streaming updates (including, e.g., jackpot amounts, cumulative payouts, etc.) to overhead displays, etc.

As more and more services are being deployed and/or made available across the network, the need to reduce the size of the communications has become more and more important. For example, reducing the size of the communications would enable more and more features to be provided over the network. In addition to increasing the number of such features, the quality of existing features could be expanded. Alternatively, or in addition, reducing the size of the communications would place less stress on the communications infrastructure.

However, the gaming industry has not adjusted accordingly, despite the existence of the number of heavy-duty compression solutions available. That is, in the gaming industry, data simply is sent uncompressed. Part of the technical problem associated with implementing such compression solutions has been trying to adapt them for use in the gaming environment. For example, the peripherals on which they are expected to run tend to have limited resources in terms of, for example, processing power, memory or other storage locations, etc. Another technical challenge relates to the variety of different peripherals in place throughout a gaming environment, both in terms of purpose, style, age, and technical ability of each said peripheral.

In a typical gaming environment, communications are provided over a unicast protocol. Although a sender on the network attempt to send a separate copy of data for each recipient, the sender tends to get bogged down doing the same work over and over again. In fact, it has been determined by the inventor of the instant application that current gaming networks are only capable of implementing unicast on a network limited to about 20-30 recipients, especially when video is involved.

In one more advantageous alternative, streaming video data has been found to increase the capacity of the sender to a potential distribution of a few hundred (e.g., about 200-800) recipients. Implementing a broadcast protocol has been attempted in still another alternative arrangement. In such a broadcast arrangement, one sender sends data received by all receivers. However, this arrangement has been found to bog down the receivers when more than one broadcaster is involved, which often is the case in a gaming environment.

Thus, it will be appreciated that there is a need in the art for techniques for overcoming one or more of these and/or other drawbacks. It also will be appreciated that there is a need in the art for light-weight video transcoding techniques for allowing media (e.g., audiovisual content that may be pre-recorded media and/or live media provided in substantially real-time) to one or more peripherals (e.g., gaming devices, overhead displays, etc.) attached to gaming networks.

In certain exemplary embodiments, a video transcoder configured to provide video content from a video server to one or more peripherals connected to a networked gaming environment is provided. A network connection is configured to receive video data from the video server. Programmed logic circuitry is configured to decompress the video data into raw video data, strip down the raw video data by discarding at least some component data of the raw video data and at least some lower bits of the raw video data, run a predictor algorithm on the stripped-down raw video data, and generate recompressed data based on output of the predictor algorithm in accordance with a compression algorithm to be sent to one or more peripherals connected to the gaming network over the network connection. The recompressed data is suitable for playback on the one or more peripherals receiving the recompressed video data after decompression and component substitution processes performable by the one or more peripherals have completed.

In certain exemplary embodiments, a networked gaming system including a gaming network is provided. A plurality of gaming peripherals are provided. The gaming peripherals include one or more gaming machines, table games, and/or overhead displays. A video server is configured to provide video data for either direct or indirect display on at least one said gaming peripheral in the plurality of gaming peripherals. A video transcoder is configured to provide the video data from the video server to at least one said peripheral, with the video transcoder comprising programmed logic circuitry configured to decompress the video data into raw video data, strip down the raw video data by discarding at least some component data of the raw video data and at least some lower bits of the raw video data, run a predictor algorithm on the stripped-down raw video data, and generate recompressed data to be sent to the at least one peripheral based on output of the predictor algorithm in accordance with a compression algorithm. The at least one peripheral is configured to play back the video data after decompressing the recompressed video data and generating substitutes for the discarded component data.

In certain exemplary embodiments, a method of distributing video data over a gaming network for playback on a peripheral connected to the gaming network is provided. Video data to be distributed is received from a video server. The video data is decompressed into raw video data. The raw video data is stripped down by discarding at least some component data of the raw video data and at least some lower bits of the raw video data. A predictor algorithm is run on the stripped-down raw video data. Recompressed data to be sent to one or more peripherals is generated based on output of the predictor algorithm in accordance with a compression algorithm.

The recompressed data may be received at at least one peripheral, the recompressed data may be decompressed, and existing component data may be substituted for the discarded component data.

The raw video data may include YUV component data in certain exemplary embodiments. Also, in certain non-limiting implementations, every other row of U and V component data may be discarded, the lowest two bits of data may be discarded from at least one of the Y, U, and V components, the compression algorithm may a Huffman-like coding scheme, and/or the predictor algorithm may be a median predictor algorithm.

These exemplary features, aspects, and advantages may be combined in various combinations and ways to achieve yet further embodiments.

### BRIEF DESCRIPTION OF THE DRAWINGS

These and other features, aspects, and advantages will be better and more completely understood by reference to the following detailed description of exemplary illustrative embodiments in conjunction with the drawings, of which:

FIG. 1 shows a plurality of gaming machines and associated peripherals being located on a casino floor and being connected in a networked environment, in accordance with an exemplary embodiment;

FIG. 2 is an illustrative flowchart showing a process for transcoding video data, in accordance with an exemplary embodiment;

FIG. 3 is a more detailed view of an illustrative sub-process for generating recompressed transcoded video data, in accordance with an exemplary embodiment;

FIG. 4 is an illustrative flowchart showing a process for decompressing transcoded video data, in accordance with an exemplary embodiment;

FIG. 5 shows a plurality of table games and associated peripherals being located on a casino floor and being connected in a networked environment, in accordance with an exemplary embodiment;

FIG. 6 is a partial schematic view of a casino floor including connections to gaming machines and table games in accordance with an exemplary embodiment;

FIG. 7 is an illustrative multi-property layout of gaming machines and table games in accordance with an exemplary embodiment; and

FIG. 8 is another illustrative multi-property layout of gaming machines and table games in accordance with an exemplary embodiment.

### DETAILED DESCRIPTION

The exemplary embodiments described herein relate to light-weight video transcoding techniques for allowing media (e.g., audiovisual content that may be pre-recorded media and/or live media provided in substantially real-time) to one or more peripherals (e.g., gaming devices, overhead displays, etc.) attached to gaming networks. Video data to be distributed is received from a video server. The video data is decompressed into raw video data. The raw video data is stripped down by discarding at least some component data of the raw video data and at least some lower bits of the raw video data. A predictor algorithm is run on the stripped-down raw video data. Recompressed data to be sent to one or more peripherals is generated based on output of the predictor algorithm in accordance with a compression algorithm. The recompressed data may be received at at least one peripheral, the recompressed data may be decompressed, and existing component data may be substituted for the discarded component data.

The raw video data may include YUV component data in certain exemplary embodiments. Also, in certain non-limiting implementations, every other row of U and V component data may be discarded, the lowest two bits of data may be discarded from at least one of the Y, U, and V components, the compression algorithm may be a Huffman-like coding scheme, and/or the predictor algorithm may be a median predictor algorithm.

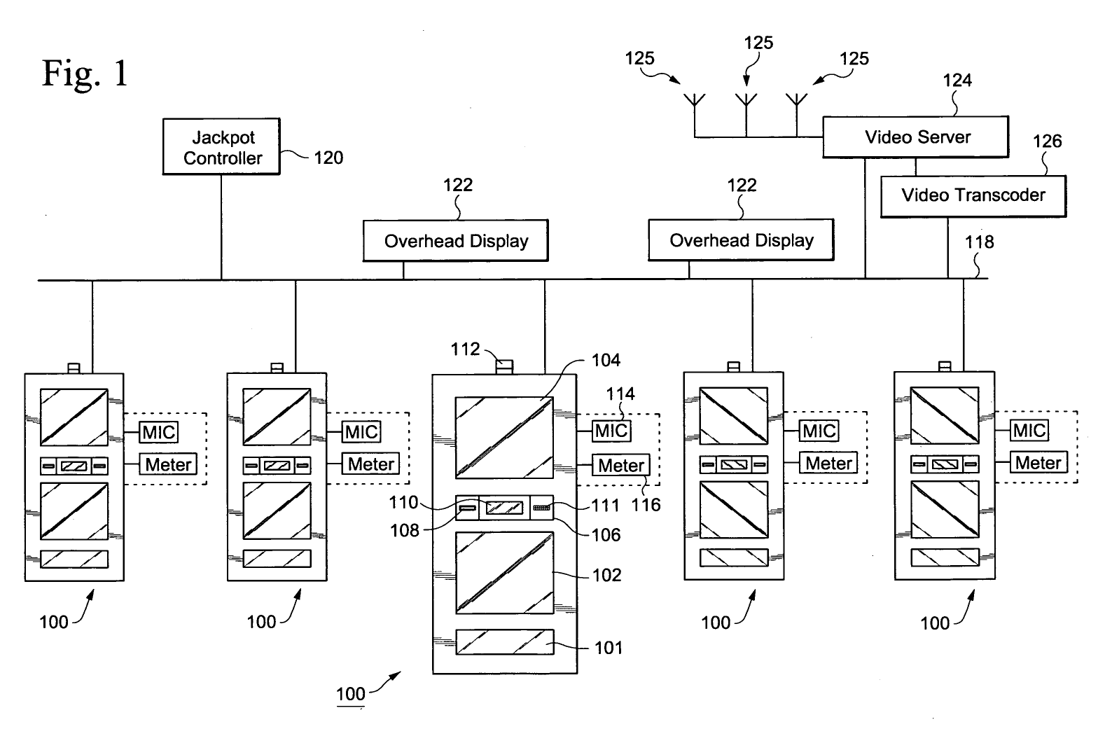

Referring now more particularly to the drawings, FIG. 1 shows a plurality of gaming machines 100 and associated peripherals being located on a casino floor and being connected in a networked environment. For aesthetic purposes, belly glass 101 often is provided on gaming machines. Each gaming machine includes a first display area 102, generally referred to as a game screen. The game screen 102 traditionally has been where most of the “action” happens. For example, the game screen 102 may simulate the rolling of the reels on a slot machine and thus indicate whether the user has won any money. A second display area 104, generally referred to as a top box, also is provided. The top box 104 may display additional information for the patron, such as, for example, advertising, generally entertaining animations, bonus game opportunities, etc.

The game screen 102 and/or the top box 104 may be touch screen monitors and thus accept input directly. Such input may pertain to, for example, the number of credits to bet, the way in which a bet may be made, whether to initiate a bet, whether to cash out, etc. In other cases, a separate control panel (not shown) may be provided to enable the same and/or similar functionality.

The gaming machine 100 also is provided with a player tracking module (PTM) area 106. The PTM area 106 includes a payment acceptor (e.g., a card reader) 108 to accept payment (e.g., cash, an encoded card storing credits, or the like) from the patron. A small display screen (or PTM) 110 is located in the PTM area 106 and enables the patron to access certain other more individualized services. For example, the PTM 110 may enable the patron to call an attendant to order drinks. In such a case, the PTM 110 may cause the candle 112 (e.g., one or more differently colored lights) of the gaming machine 100 to become lit to signal to casino personnel that the patron is requesting some form of service. The PTM 110 typically is an LCD screen and typically is operated using control panel 111.

The PTM 110 may have a computer-readable storage medium (not shown) associated therewith. The computer-readable storage medium typically is a small flash drive, hard drive, or other suitable memory location. Information may be distributed to the PTM 110 and at least temporarily stored on the computer-readable storage medium. In this way, it is possible to provide some media offerings to the gaming machine 100 for display by the PTM 110. More particularly, the computer-readable storage medium is used as a buffer for the media offerings that ultimately may be displayed by the PTM 110.

The game screen 102 and the top box 104, and the respective associated circuitry, typically are provided by a single company. The PTM 110 often is provided by another vendor. Sometimes, the PTM 110 will be integrated into the gaming machine 100. However, it is often the case that the gaming machine 100 will be retrofitted with a PTM 110. As such, the hardware and software systems for the game screen 102 and the top box 104 typically are independent of the hardware and software systems for the PTM 110.

This separation often makes integration between the various components cumbersome. Thus, to accommodate these features related to the PTM area 106, gaming machines are equipped with special purpose hardware. It will be appreciated that the player management tracking and information management features provided typically exist outside of the normal base game(s) environment, which deal directly with game play rather than ancillary services, patron interaction, feedback, and the like.

It will be appreciated that although the gaming machines 100 shown in FIG. 1 all appear the same, the present invention is not so limited. A wide variety of gaming machines may be provided, table games, roulette tables, etc. may be provided, in terms of configuration, style, type, functionality, payoffs, etc.

In many cases, an RS-485 connection is utilized. The connection often is to a machine interface card (or MIC) 114 located within each gaming machine. In essence, the MIC 114 translates between the gaming machine 100 and the network 118, making all such gaming machines appear to be the same from the perspective of the network 118.

As alluded to above, a plurality of gaming machines 100 may be located on a casino floor and being connected in a networked environment, e.g., via network 118. To this end, a plurality of central systems (not shown) are connected to the networked environment to collect and/or distribute data, as necessary. Each gaming machine 100 may be connected to one or more of the central systems via a network link. Such network links typically are proprietary and are based on unicast, broadcast, multi-drop, and/or other suitable network protocols. Although proprietary protocols often are implemented, the typical effect is that data is transmitted by the central systems over a broadcast channel or to one or more targeted groups (e.g., a bank of gaming machines in a row, in a particular area of the gaming floor, etc.) over connections.

There are at least three separate systems or modules comprising the central systems. A first system, management and accounting subsystem, provides management and accounting functions, also sometimes called auditing functions. Typically, these functions gather and/or report coin-in and coin-out operations, door openings (e.g., when a gaming machine is serviced), service cycles in general, ticket replacements, and the like. This activity generally is linked to the game being played on the gaming machine and/or the gaming machine itself.

A second system, player tracking subsystem, provides player tracking functions. More specifically, such systems link players on the gaming floor to particular activities undertaken by the players on the gaming floor. The information typically tracked for each player includes, for example, the session of game play (e.g., date, time, location, type of machine, type of game, etc.) as well as the individual's profile (e.g., name, address, and/or other identifying information such as hair color). The player tracking subsystem also may interface with the PTM 110 of a particular gaming machine 100.

A third system, bonusing subsystem, provides enhancements which may or may not be related to the base game. Such enhancements may relate to bonusing, progressive games, mystery, secondary games, random rewards, etc. This system typically interfaces with the PTM 110.

Other systems may be included in the central systems 114. For example, other modules may be provided for detecting cash-in, cash out and/or data mining purposes. Data mining may be used, for example, in connection with marketing activities, accounting and/or auditing activities, etc.

Reports may be generated by the central systems, for example, to report on earnings, operational efficiencies, repairs, etc. Such reports also may be the result of the above-described data mining operations.

An in-machine meter 116 may be provided to the gaming machines 100 to cooperate with the central systems (e.g., to provide information regarding game plays, amounts of wagers, payoffs, etc.).

In addition to the gaming machines 100 existing in the network, one or more overhead displays 122 may be connected to the network 118. The overhead displays 122 may receive data from the central systems indicating, for example, the jackpot amount(s) (e.g., current, daily, monthly, etc.), payouts (e.g., current, daily, monthly, etc.), winners, etc.

A jackpot controller 120 also is connected to the network 118. A single jackpot controller may be assigned to a bank of gaming machines 100. Typically, 124 gaming machines comprise a bank. The jackpot controller 120 may be responsible for calculating jackpots, changing the turnover on every hit and/or on every play, returning the winning amounts, etc.

In certain exemplary embodiments, the illustrative techniques described herein may be implemented as programmed logic circuitry (e.g., any suitable combination of hardware, software, and/or firmware) and thus may be tangibly stored as instructions on a computer-readable storage medium. Furthermore, in certain exemplary embodiments, the transcoder and/or the end-peripheral devices on which the content is to be displayed may include computer-readable storage mediums (e.g., memory locations, disk drive devices, flash drives, etc.), for example, to at least temporarily store data for, during, and/or after processing.

A video server 124 also is provided to the network 118. The video server 124 is configured to receive one or more feeds 125. For example, one or more of the feeds 125 may be live feeds, e.g., from a satellite, cable, antenna, television, closed-loop, or other source. Thus, the live feeds 125 may provide access to, for example, live sporting events, television programs, movies, events or shows occurring within the gaming establishment, etc. One or more of the feeds 125 also may be feeds from pre-recorded media establishments. In such a case, one or more media databases (not shown) may be in connection with the feeds 125 and/or the video server 124. Thus, the pre-recorded feeds 125 may provide access to, for example, television programs, movies, advertising, canned special effects (e.g., when an award is made), etc. Other feeds 125 may be provided to the video server 124, and/or the video server 124 may generate its own content. For example, the video server 124 may be in communication with the jackpot controller 120 to receive information about current jackpot sizes, payout amounts and/or frequencies, etc. Of course, it will be appreciated that the foregoing description is provided by way of example and without limitation, and that other media sources may be used in connection with certain of the example embodiments described herein such that, e.g., video content is provided directly to and/or generatable by the video server 124 from a variety of possible sources.

As noted above, the video server 124 is in communication with the network 118. This type of communication may be direct or indirect. Some of the peripherals attached to the network 118 may be able to handle video streams from the video server 124 without the need for the illustrative transcoding techniques described herein. Also, some of the peripherals attached to the network 118 may not be capable of accepting the illustrative transcoding techniques described herein. Thus, in certain exemplary embodiments, it may be advantageous to provide at least some video signals from the video server 124 directly to the network 118.

In addition, or in an alterative, to such direct connections between the video server 124 and the network 118, the video server may have an indirect connection to the network 118 in certain other exemplary embodiments. In such cases, the video server 124 may be connected to the network 118 via a video transcoder 126. The video transcoder 126 may be any suitable combination of programmed logic circuitry (e.g., hardware, software, firmware, and/or the like) capable of receiving a video data from the video server 124. The video data may be, for example, in an MPEG, AVI, SWF, MOV, WMV, or any other format. The video data may be streaming or not streaming in certain exemplary embodiments. In brief, this video data is separated into audio and video, and at least the video is re-encoded into a format in accordance with an exemplary embodiment. The audio may or may not be re-encoded to a new or existing form. Then, at least the re-encoded video is transmitted by the video transcoder 126 for playback on a peripheral attached to the network 118.

The video server 124 also may be a streaming or non-stream video server. Also, the video server may transmit video data to the network and/or to the video transcoder 126 using a multicast protocol. Similarly, the video transcoder 126 may transmit the data to the peripherals on the network 118 using a multicast protocol. 10048] In brief, in a multicast communication scheme, each sender device sends only one copy of data to the network. The network (or programmed logic circuitry operably connected to the network) maintains a subscriber list, and receivers connected to the network subscribe to multicast channels. Some or all of network 118 may be provided according to a multicast communication scheme. Thus, streaming media, whole files, gaming data (e.g., information pertaining to progressive games, individual gaming device accounting data, etc.), and/or the like may be communicated in such a multicast environment.

As such, referring again to the example arrangement shown in FIG. 1, individual gaming machines 100, overhead displays 122, etc., (or coordinating programmed logic circuitry therein) may subscribe to various video channels provided to the network 118 by the video server 124 and/or the video transcoder 126.

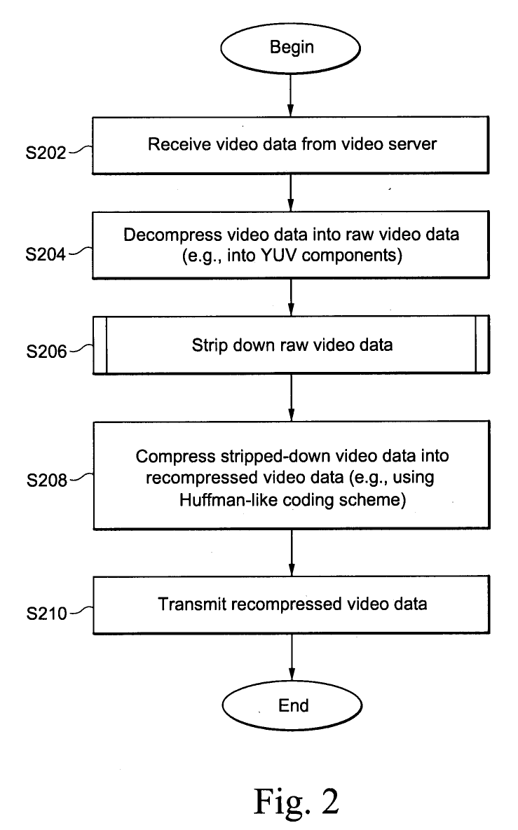

A description of exemplary transcoding techniques will now be made with reference to FIGS. 2-4. In particular, FIG. 2 is an illustrative flowchart showing a process for transcoding video data, in accordance with an exemplary embodiment. In step S202, video data is received from a video server. As noted above, the video data may be in any suitable video format, such as, for example, an MPEG, AVI, SWF, MOV, WMV, or other format. For illustrative purposes, the following description will be made with reference to the MPEG-2 video format. However, as noted above, it will be appreciated that the exemplary transcoding techniques may be applied to other video formats.

In step S204, the video data is decompressed into raw video data. This process may include breaking down the MPEG-2 data into its components (e.g., YUV components, also sometimes referred to as YCbCr components in the digital video arts). Y refers to luma or luminance, and U and V refer to chrominance components (e.g., blue and red chrominance components, respectively).

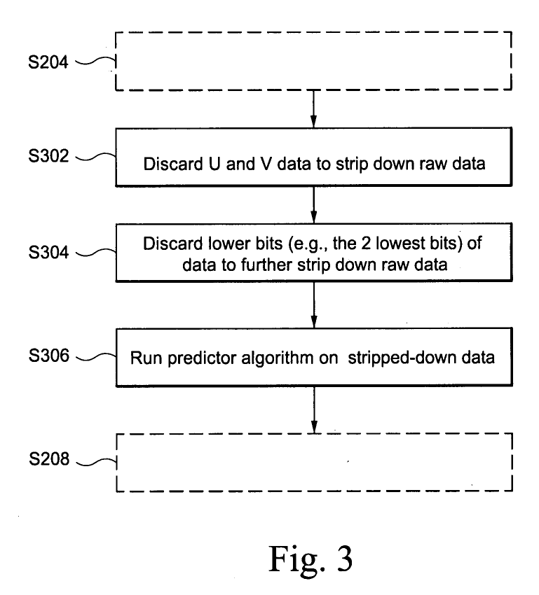

In step S206, the raw video data is stripped down, e.g., to make it more compressable. Further details of this process are provided below, e.g., with reference to FIG. 3. In step S208, the stripped-down raw video data is compressed into recompressed video data, for example, using a Huffman-like coding scheme. The ZLIB library is one example Huffman-like coding scheme that may be used in connection with certain exemplary embodiments, although it will be appreciated that any compression technique suitable for compressing image and/or video may be used in connection with the exemplary embodiments herein, regardless of whether such compression techniques are Huffman-like in nature.

At least the recompressed video data is transmitted in step S210 (e.g., via multicast). In certain exemplary embodiments, the audio data may or may not be modified. That is, in certain exemaplry embodiments, the audio data may be left as-is, may be compressed (using a similar or other technique), may not be transmitted at all, etc.

FIG. 3 is a more detailed view of an illustrative sub-process for generating recompressed transcoded video data, in accordance with an exemplary embodiment. Thus, FIG. 3 provides one example sub-process that may be used in connection with step S206 in FIG. 2. Certain exemplary embodiments provide a variation on the Huff YUV codec. Briefly, the HuffU codec compresses an image by predicting the value of a pixel from its neighbors and computes an error value (delta) by subtracting it from the effective pixel value. In the base HuffYUV codec, the result is compressed with a Huffman algorithm, using a different table for each channel. To decompress a frame, the decoder needs to reverse this process (e.g., extract the error value from the compressed Huffman stream, reconstruct the pixel value by computing the predictor value, and add it to the error value). A start value (e.g., the first pixel in a frame) is known, and a predictor uses only values from past pixels (which are already decompressed).

With respect to certain exemplary embodiments described herein, in greater detail, in the uncompressed MPEG-2 example, there are two Y components and shared U and V components. Thus, pixels normally are presented in the following format:

. . . [Y1an Uan Y2an Van] [Y1am Uam Y2am Vam] . . .
. . . [Y1bn Ubn Y2bn Vbn] [Y1bm Ubm Y2bm Vbm] . . .

In this illustrative pixel diagram, a and b are row indexes and n and m are column indexes.

In step S302, at least some of the U and V data is discarded to partially strip down the raw data. For example, the U and V data of every other row, every third row, etc., may be thrown out. The following diagram shows every other row of U and V data being thrown out (e.g., where the dashes appear). It will be appreciated that rather than completely throwing out data, zeros may be included in their place in certain exemplary embodiments.

| . . . [Y1an | Uan | Y2an | Van] | [Y1am | Uam | Y2am | Vam] . . . |
|---|---|---|---|---|---|---|---|
| . . . [Y1bn | - - - | Y2bn | 0 ] | [Y1bm | - - - | Y2bm | - - -] . . . |
| . . . [Y1cn | Ucn | Y2cn | Vcn] | [Y1cm | Ucm | Y2cm | Vcm] . . . |
| . . . [Y1dn | - - - | Y2dn | 0 ] | [Y1dm | - - - | Y2dm | - - -] . . . |

To further strip down the data, at least some of the lower bits of data are discarded (e.g., replaced with zeros). In a typical color space, the Y, U, and V components each are represented by 256 bits of data. Thus, carefully removing a few of the lower bits generally will not lead to a perceivable difference in appearance, and certain exemplary embodiments therefore may remove a number of pixels without causing a perceivable degradation in video quality. By way of example and without limitation, 1, 2, 3, or even more bits of data may be zeroed to further strip down the data. Of course, it will be appreciated that removing too many bits of data will cause a perceivable change in the visual appearance of the video.

Again, by way of example and without limitation, the following pseudo-code illustrates a process for zeroing out the lower 2 bits of data for each of the two Y components and the shared U and V components:

pixpair.y1 = pixpair.y1 & 0xFC;
pixpair.u = pixpair.u & 0xFC;
pixpair.y2 = pixpair.y2 & 0xFC;
pixpair.v = pixpair.v & 0xFC;

where pixpair is a data structure for a pixel pair (e.g., a double Y with a shared U and V), the “&” symbol is a bitwise and, and “0xFC” is the hexadecimal representation for 252. Thus, each of the bitwise representations of the y1, u, y2, and v components will be anded with a string, from left to right, of six 1s and two 0s (11111100) so as to zero out the lower 2 bits of data while maintaining the upper 6 bits. In other words, introducing a possible error of up to 3 out of 256 (e.g., just over 1%) is difficult to perceive. Errors may be perceived in subtle gradients; however, such gradients typically rarely appear in videos and, in any case, such errors typically are not noticed by most people (especially when they are at least partially occupied with game play at a casino).

Of course, it will be appreciated that more than 8 bits of color data may be provided in connection with certain exemplary embodiments and thus it may be possible to zero out more of the lower bits without introducing a perceivable change in video quality. Also, it will be appreciated that although all of the components are shown as having there lower-bits dropped, in certain exemplary embodiments, the lower bits of only some of the components may be dropped. Thus, for example, more bits of Y1 and/or Y2 data may be maintained as compared to the U and V data, etc.

A predictor algorithm is run on the data in step S306. In general, predictors are used to predict the value of the next pixel so that the compression algorithm needs to store only the error between the real pixel value and the prediction. If the prediction model is good, the error will be small and the video will compress better than full pixel values. A median predictor algorithm may be used in connection with certain exemplary embodiments. The median predictor for a pixel is the median value among the pixel to the left, the pixel above, and the gradient predictor (e.g., the sum of the previous pixel and the above pixel, minus the above left pixel). The median may be obtained, for example, by sorting the three values and taking the middle value.

In connection with certain exemplary embodiments, the first pixel of the video frame is stored uncompressed, whereas the remaining pixels of the first row and the first 4 pixels of the second row are compressed with the predict left algorithm. The rest of the second row and other rows are compressed with predict median. In certain exemplary embodiments, the second pixel of the second row may be compressed using the median predictor rather than the left predictor.

Thus, it can be seen that stripping down the raw data in the above-described and/or other ways is advantageous for several reasons. For example, the introduction of zeros in the bit streams of the components reduces the error values that ultimately need to be stored. Also, there is little loss in the quality of the image. This is particularly true because discarding U and V values generally is not as noticeable as discarding Y values, as the human eye is believed to be more sensitive to variations in the intensity of a pixel rather than variations in color.

Surprisingly and unexpectedly, the above-described illustrative techniques have been found to compress video approximately 40-50%. In certain exemplary implementations, this advantageously may place less burden on a video server, reduce the processing requirements placed on peripheral devices, reduce network strain, result in lower latencies, provide substantially real-time streams of media, free bandwidth, etc. Thus, in certain exemplary embodiments, about 4,000-5,000 or even more players may be supported within a gaming environment. It also is even possible in certain illustrative implementations to use the compression and/or multicast techniques described herein to potentially individualize each player display.

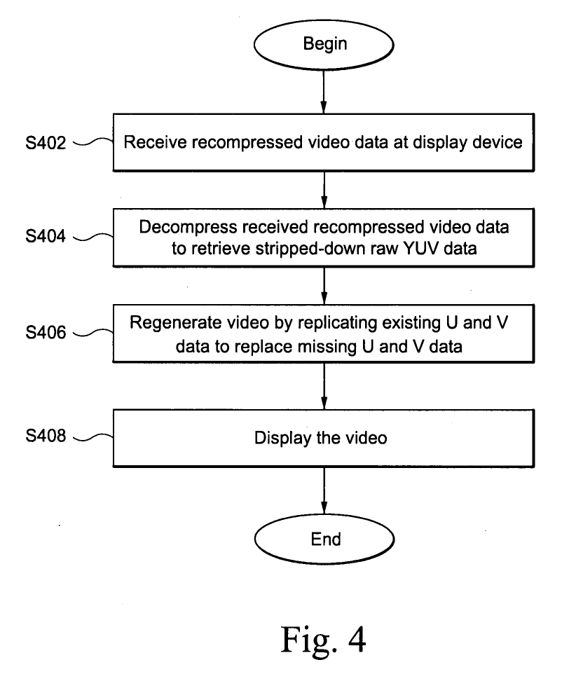

FIG. 4 is an illustrative flowchart showing a process for decompressing transcoded video data, in accordance with an exemplary embodiment. At a display device (which may be a receiving peripheral such as, for example, a gaming machine, table game, overhead display, etc.), the recompressed video data is received. The received recompressed video data is decompressed to retrieve the stripped-down raw YUV data in step S404. The decompression in step S404 may be accomplished using a decompression technique corresponding to the compression technique used in connection with step S208 in FIG. 2.

After step S404, the data will include missing U and V values in accordance with the parameters selected for the stripping down process of step S302 in FIG. 3. Because many video playback codecs will not be able to accommodate such missing info, in step S406, the raw video data may be regenerated (e.g., approximated or substituted) by replicating existing U and V data to replace the missing U and V data. For example, in certain exemplary embodiments where every other row is skipped, the missing U and V values may be borrowed from the U and V data in the immediately preceding row. Thus, after the regeneration, the raw data may be represented as follows:

. . . [Y1an Uan Y2an Van] [Y1am Uam Y2am Vam] . . .
. . . [Y1bn Uan Y2bn Van] [Y1bm Uam Y2bm Vam] . . .
. . . [Y1cn Ucn Y2cn Vcn] [Y1cm Ucm Y2cm Vcm] . . .
. . . [Y1dn Ucn Y2dn Vcn] [Y1dm Ucm Y2dm Vcm] . . .

Of course, it will be appreciated that other regeneration rules may be applied. For example, in certain exemplary embodiments, the missing U and V data may be an average between upper and lower rows, etc. This approximation technique works well because Y data is maintained whereas only a portion of U and V data is lost, losses in the Y data generally being more perceivable during video playback than losses in the U and V data.

The video ultimately may be displayed in step S408.

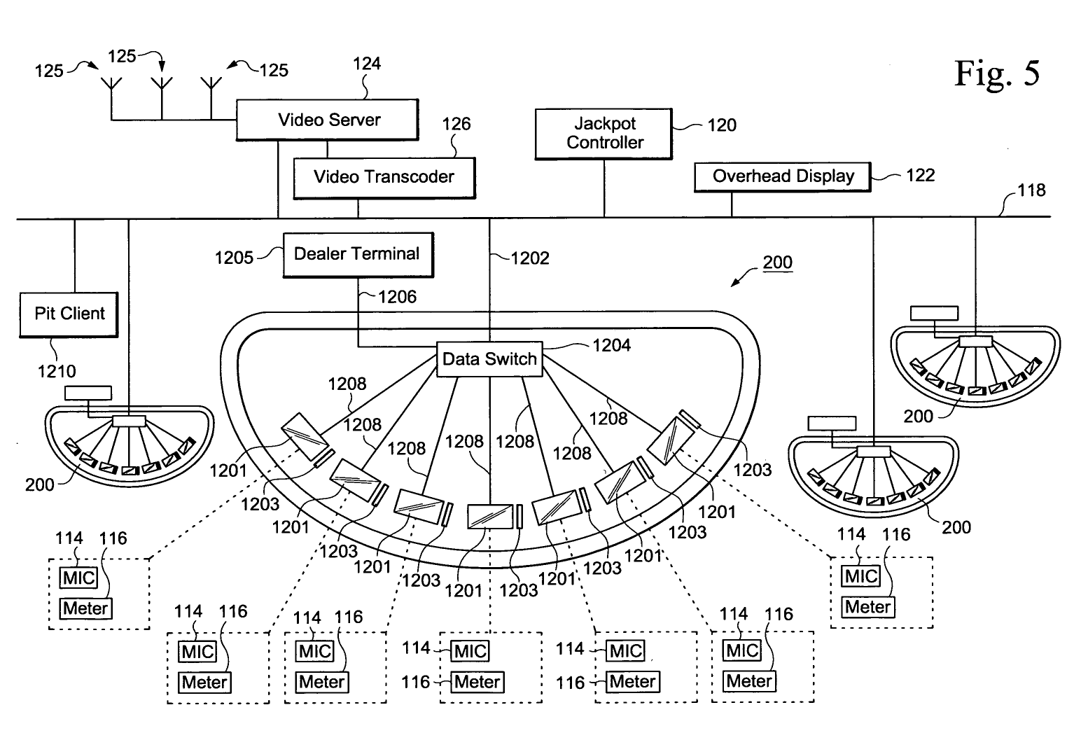

It will be appreciated that similar techniques may be applied to table games. For example, FIG. 5 shows a plurality of table games 200 and associated peripherals being located on a casino floor and being connected in a networked environment, in accordance with an exemplary embodiment. In FIG. 5, each table 200 has a number of player positions. More particularly, seven player positions are shown, as this is the customary number of player positions at blackjack tables, for example. Of course, the invention is not limited to a particular number of player positions or to any particular table game.

Each player position includes a display 1201 and a payment acceptor and/or card reader 1203 (similar to the payment acceptor 108 described above). The player may have the ability to place side wagers and/or a main wager via the interface offered by the display 1201. Each player position also includes a MIC 114 and an in-table meter 116, similar to the components described above with relation to FIG. 1. These components are not shown at every table 200 for the sake of readability of FIG. 5.

There also is a dealer terminal 1205 provided to each table. The dealer terminal 1205 includes a player representation and a keypad. The dealer may use the dealer terminal to make player credits/debits, retrieve the status of any player (e.g., amount of credits, whether the player is a preferred patron, etc.), and the like. For example, the dealer may designate a player in the player representation and indicate, via the keypad, whether to credit/debit the player's account, what the player's hand included, etc.

Data may be logged (e.g., to one or more databases of the central servers) during and/or after the play of each player.

A connection 1202 is provided to each table 200 from the network 118 so as to connect each respective table 200 to, for example, the central systems (not shown) and the jackpot controller 120 via a data switch 1204. Via connection 1206, the data switch connects the dealer terminal 1205 to the network 118. Similarly, via connection 1208, the data switch 1204 connects each of the player positions to the network 118.

In certain exemplary embodiments, each table 200 will have its own associated data switch 1204. In such exemplary instances, the network 118 may be kept more “flat” and thus network latencies may be decreased. However, in certain other exemplary embodiments, the player positions and the dealer terminal may be directly addressable across the network 118.

A pit client 1210 also sits on the network 118. A pit, or area of table games within a casino, typically comprises 2-12 such tables. There may be multiple pits within a single casino. One or two pit bosses typically are assigned to a pit. In place of or in addition to pit bosses, the pit client 1210, via its connection to the central systems and to the tables individually, may provide substantially real-time player ratings. These player ratings may be actual, rather than merely estimated, ratings. In addition to actual and substantially real-time ratings, actual substantially real-time player and table accountings may be gathered. Moreover, promotional and/or contributional bonusing may be provided based on an individual's identity, an individual player's rating, on a particular table's action, on the action within a pit, on a property-wide basis, according to a multi-property basis, etc.

Although a single jackpot controller 120 is shown on the network, the present invention is not so limited. For example, a jackpot controller 120 or an instance of a jackpot controller 120 may be provided to each pit.

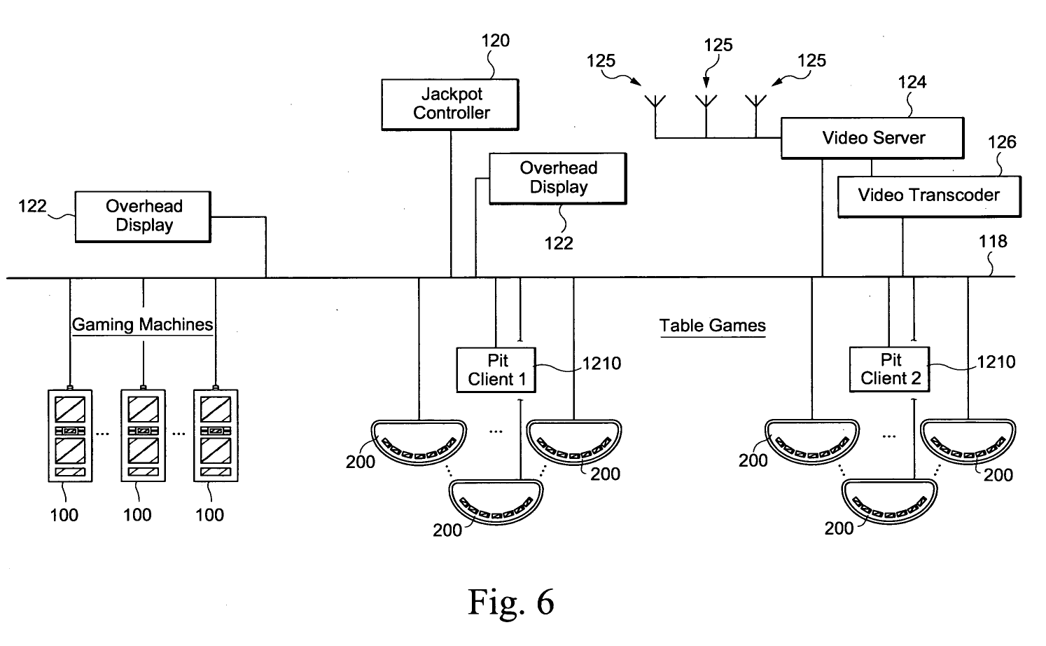

FIG. 6 is a partial schematic view of a casino floor including connections to gaming machines 100 and table games 200 in accordance with an exemplary embodiment. The gaming machines 100 and table games 200 are, of course, connected to the network 118. The table games 200 may be divided into one or more pits, as is conventional. In FIG. 6, a single video server 124 and video transcoder 126 are provided for all of the gaming machines 100, tables 200, overhead displays 122, etc., in the gaming establishment.

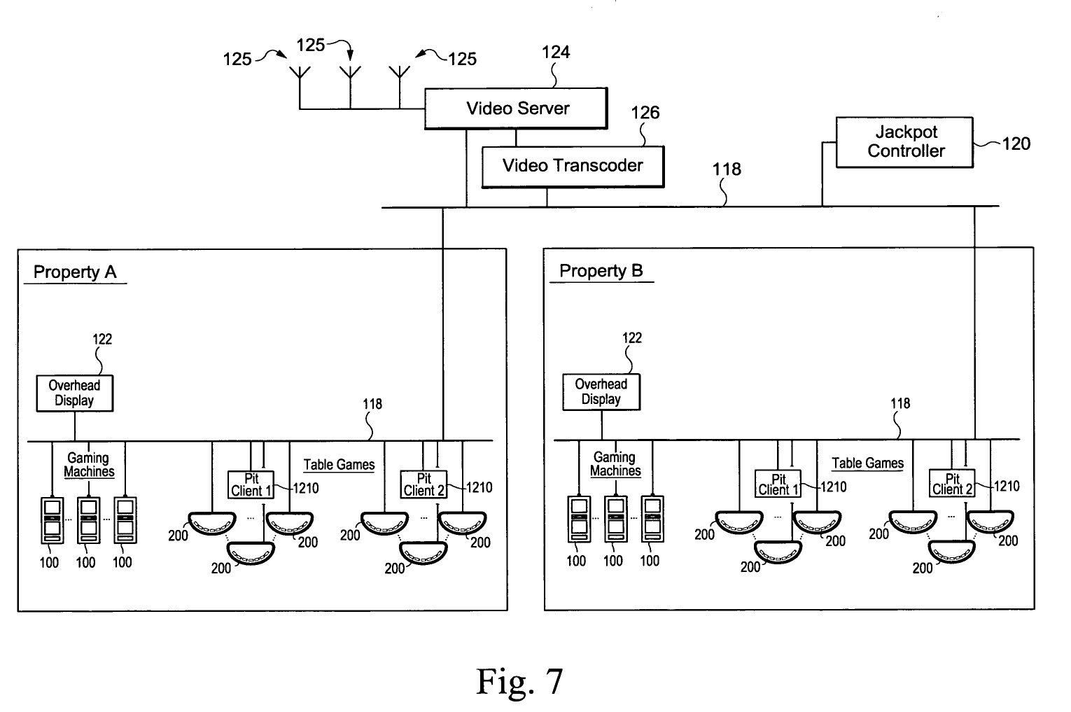

FIG. 7 is an illustrative multi-property layout of gaming machines 100 and table games 200 in accordance with an exemplary embodiment. In FIG. 7, a master video server 124 and master video transcoder 126 are provided for all of the gaming machines 100, tables 200, overhead displays 122, etc., across all of the gaming properties. Thus, although there is a master video server 124 and master video transcoder 126, there is no “master location” in the exemplary embodiment shown in FIG. 7.

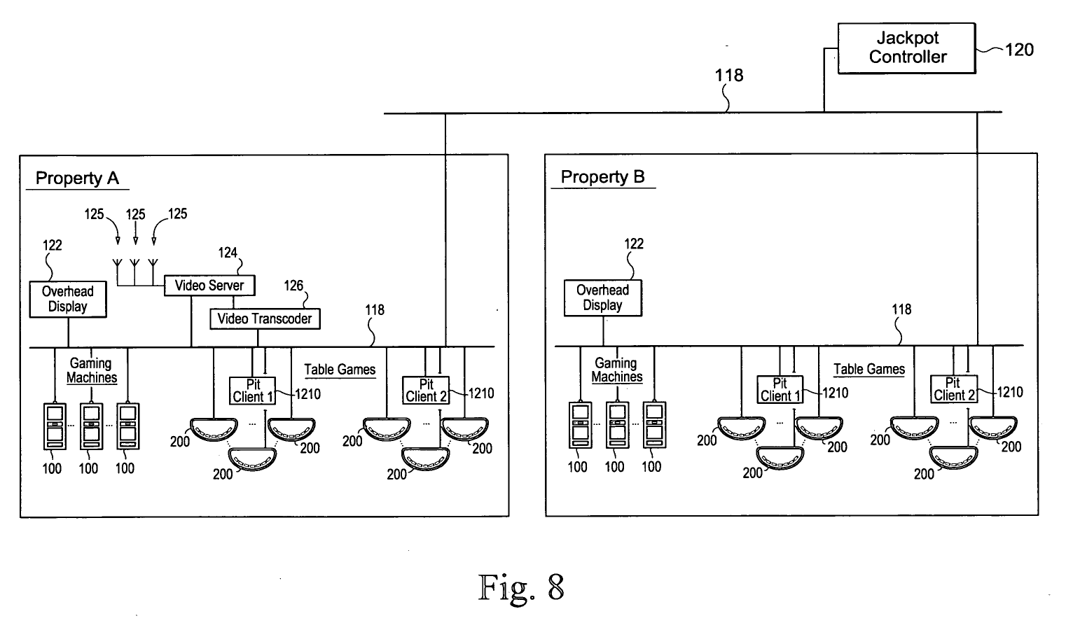

By contrast, FIG. 8 is another illustrative multi-property layout of gaming machines 100 and table games 200 in accordance with an exemplary embodiment. In FIG. 8, a master video server 124 and master video transcoder 126 are provided for all of the gaming machines 100, tables 200, overhead displays 122, etc., across all of the gaming properties. However, the master video server 124 and master video transcoder 126 are provided within a single property (in the case of FIG. 8, Property A). Thus, in the exemplary embodiment shown in FIG. 8, Property A is a master location.

In certain exemplary embodiments, each property may have its own video server and/or video transcoder. In certain exemplary embodiments, multicast transmissions may be provided within a single, and across multiple, properties. In certain other exemplary embodiments, multicast networks may be provided within each property, but property-to-property communications may take place over a different kind of network (e.g., a unicast, broadcast, or other network). In such cases, a slave sight optionally may have programmed logic circuitry to simulate a connection to a master sight (e.g., by storing data and imitating responses that would come from the master sight) in the event that a connection between properties is lost.

In certain exemplary embodiments, the chrominance may be horizontally and vertically sub-sampled by a factor of two relative to the luminance. In certain exemplary embodiments, other video components may be used, such as, for example, RGB, YCrCb, Y′CrCb, and/or other components.

It will be appreciated that although certain exemplary embodiments have been described as relating to gaming machines and table games, the present invention is not so limited. For example, the exemplary techniques associated with gaming machines may be used on table games, and vice versa. Moreover, the exemplary techniques may be used on both gaming machines and table games, simultaneously, in a suitably configured networked environment. Also, the techniques may be applied to roulette tables, bingo games, etc.

Although certain exemplary embodiments have been described as relating to gaming machines and table games in casinos, it will be appreciated that the present invention is not so limited. For example, the exemplary embodiments described herein may be used in connection with casinos, riverboats, restaurants, hotels, etc.

Instead of, or in addition to, content being provided directly on the main screen, top box, and/or PTM of gaming machines, directly on display areas of table games, and/or other information being displayed on overheads, kiosks, and/or the like, it will be appreciated that such content may be displayed and/or redisplayed on one or more floatable layers provided to any gaming device and/or display in the network gaming environment. Floatable layers are described in for example, co-pending and commonly-assigned application Ser. Nos. 11/889,970 and 11/889,971, the entire content of each of which are hereby incorporated herein by reference.

Thus, the exemplary features, aspects, and advantages described herein may be combined in yet further ways to achieve further embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A video transcoder configured to provide video content from a video server to one or more peripherals connected to a networked gaming environment, the video transcoder comprising:
a network connection configured to receive video data from the video server; and
programmed logic circuitry configured to decompress the video data into raw video data, strip down the raw video data by discarding at least some component data of the raw video data and at least some lower bits of the raw video data, run a predictor algorithm on the stripped-down raw video data, and generate recompressed data based on output of the predictor algorithm in accordance with a compression algorithm to be sent to one or more peripherals connected to the gaming network over the network connection,
wherein the recompressed data is suitable for playback on the one or more peripherals receiving the recompressed video data after decompression and component substitution processes performable by the one or more peripherals have completed.

2. The transcoder of claim 1, wherein the compression algorithm is a Huffman-like coding scheme.

3. The transcoder of claim 1, wherein the raw video data includes YUV component data.

4. The transcoder of claim 3, wherein the programmed logic circuitry is further configured to discard every other row of U and V component data.

5. The transcoder of claim 3, wherein the programmed logic circuitry is further configured to drop the lowest two bits of data from at least one of the Y, U, and V components.

6. The transcoder of claim 3, wherein the predictor algorithm is a median predictor algorithm.

7. The transcoder of claim 3, wherein the programmed logic circuitry is further configured to discard every other row of U and V component data, and to drop the lowest two bits of data from at least one of the Y, U, and V components,
wherein the compression algorithm is a Huffman-like coding scheme, and
wherein the predictor algorithm is a median predictor algorithm.

8. The transcoder of claim 1, wherein the video content is a streaming video.

9. The transcoder of claim 1, wherein the video content is live video content.

10. The transcoder of claim 9, wherein the live video content is displayable substantially in real-time on the one or more peripherals.

11. The transcoder of claim 9, wherein the live video content is based on a live satellite, cable, closed-circuit, or broadcast television feed.

12. The transcoder of claim 1, wherein the video content is pre-recorded or canned video content.

13. The transcoder of claim 12, wherein the pre-recorded or canned video content is advertising content, an animation corresponding to a game event, or a movie.

14. The transcoder of claim 1, wherein each said peripheral is a gaming machine, table game, or overhead display.

15. The transcoder of claim 1, wherein the network connection is a multicast network connection.

16. The transcoder of claim 1, wherein the video data is compressed, on average, about 40-50%.

17. A networked gaming system including a gaming network, comprising:
a plurality of gaming peripherals, said gaming peripherals including one or more gaming machines, table games, and/or overhead displays;
a video server configured to provide video data for either direct or indirect display on at least one said gaming peripheral in the plurality of gaming peripherals;
a video transcoder configured to provide the video data from the video server to at least one said peripheral, the video transcoder comprising programmed logic circuitry configured to decompress the video data into raw video data, strip down the raw video data by discarding at least some component data of the raw video data and at least some lower bits of the raw video data, run a predictor algorithm on the stripped-down raw video data, and generate recompressed data to be sent to the at least one peripheral based on output of the predictor algorithm in accordance with a compression algorithm,
wherein the at least one peripheral is configured to play back the video data after decompressing the recompressed video data and generating substitutes for the discarded component data.

18. The system of claim 17, wherein the compression algorithm is a Huffman-like coding scheme.

19. The system of claim 17, wherein the raw video data includes YUV component data.

20. The system of claim 19, wherein the programmed logic circuitry is further configured to discard every other row of U and V component data.

21. The system of claim 19, wherein the programmed logic circuitry is further configured to drop the lowest two bits of data from at least one of the Y, U, and V components.

22. The system of claim 19, wherein the predictor algorithm is a median predictor algorithm.

23. The system of claim 19, wherein the programmed logic circuitry is further configured to discard every other row of U and V component data, and to drop the lowest two bits of data from at least one of the Y, U, and V components,
wherein the compression algorithm is a Huffman-like coding scheme, and
wherein the predictor algorithm is a median predictor algorithm.

24. The system of claim 17, wherein the video content is a streaming video.

25. The system of claim 17, wherein the video content is live video content.

26. The system of claim 17, wherein the video content is pre-recorded or canned video content.

27. The system of claim 17, wherein the gaming network is a multicast gaming network.

28. The system of claim 17, wherein the video data is compressed, on average, about 40-50%.

29. A method of distributing video data over a gaming network for playback on a peripheral connected to the gaming network, the method comprising:
receiving video data to be distributed from a video server;
decompressing the video data into raw video data;
stripping down the raw video data by discarding at least some component data of the raw video data and at least some lower bits of the raw video data;
running a predictor algorithm on the stripped-down raw video data; and
generating recompressed data to be sent to one or more peripherals based on output of the predictor algorithm in accordance with a compression algorithm.

30. The method of claim 29, further comprising:
receiving the recompressed data at at least one peripheral;
decompressing the recompressed data;
substituting existing component data for the discarded component data.

31. The method of claim 29, wherein the raw video data includes YUV component data.

32. The method of claim 31, further comprising discarding every other row of U and V component data; and
dropping the lowest two bits of data from at least one of the Y, U, and V components,
wherein the compression algorithm is a Huffman-like coding scheme, and
wherein the predictor algorithm is a median predictor algorithm.
